(19) United States
(12) Patent Application Publication
(10) Pub. No.: US 2011/0076480 A1
(43) Pub. Date: Mar. 31, 2011

(54) STRAIN TOLERANT CORROSION PROTECTIVE COATING COMPOSITIONS AND COATED ARTICLES

(76) Inventors: Andrew Jay Skoog, West Chester, OH (US); Brian Thomas Hazel, West Chester, OH (US); Jane Ann Murphy, Franklin, OH (US)

(21) Appl. No.: 12/570,402

(22) Filed: Sep. 30, 2009

(51) Int. Cl. B32B 15/04; B32B 5/16; B32B 3/26; C09D 5/08

(52) U.S. Cl. 428/312.6; 428/312.2; 428/450; 428/457; 428/472; 428/472.2; 428/469; 106/14.05

(57) ABSTRACT

A coated article suitable for use at elevated temperature includes a metal substrate and a coating on the substrate. The coating includes a corrosion resistant particulate component having an average coefficient of thermal expansion (CTE) greater than alumina at 1200° F. (649° C.) dispersed in a binder matrix. An aspect ratio of at least a portion of the corrosion resistant particulate component is greater than about 2:1. The binder matrix includes a silicon-containing material and/or a phosphate-containing material.

### BACKGROUND OF THE INVENTION

This invention relates generally to corrosion resistant coating compositions and coated articles, and more specifically to corrosion resistant coatings particularly suitable for use on non-gas flowpath turbine engine components.

Enhanced performance of gas turbine engines such as higher thrusts and better fuel economy are continuously sought. To improve the performance of the engine, the combustion temperatures have been raised to very high temperatures. Turbine engine components for use at the highest operating temperatures are typically made of superalloys of iron, nickel, cobalt, or combinations thereof or other corrosion resistant materials such as stainless steels. At such high operating temperatures, even superalloy components not within the combustion path have been subjected to degradation. One problem that has been discovered during refurbishment of high performance aircraft engines has been the pitting of turbine disks, seals, and other components that are supplied with cooling air. Engine components that are made from newer generation alloys that contain lower levels of chromium may be more susceptible to corrosion attack.

The cooling air may include ingested particulates such as dirt, volcanic ash, fly ash, concrete dust, sand, and/or various salts in either particulate or gaseous form. The observed pitting problem may be caused by the formation of a corrosion product resulting from the ambient airborne foreign particulate and gaseous matter carried in the cooling air and the higher operating temperatures.

A known coating including an alumina pigment carried in a chromate-phosphate binder, commercially marketed as SermaFlow® N3000, presents environmental challenges due to utilization of hexavalent chromium.

What is needed is a coating composition and coating system that is free of hexavalent chromium; that can provide the desired corrosion protection without adversely affecting the fatigue life of the turbine component; and that resists spallation caused by coefficient of thermal expansion (CTE) mismatches between the coating and the underlying substrate or other causes.

### BRIEF DESCRIPTION OF THE INVENTION

The above-mentioned need or needs may be met by exemplary embodiments that provide a coated article suitable for use at elevated temperature. The coated article includes a metal substrate and a coating on the substrate. The coating includes a corrosion resistant particulate component having a coefficient of thermal expansion (CTE) greater than alumina at 1200° F. (649° C.) dispersed in a binder matrix. An aspect ratio of at least a portion of the corrosion resistant particulate component is greater than about 2:1. The binder matrix includes a silicon-containing material and/or a phosphate-containing material.

In another embodiment, a coating precursor composition comprises a corrosion resistant particulate component having a coefficient of thermal expansion (CTE) greater than alumina at 1200° F. (649° C.), wherein an aspect ratio of at least a portion of the corrosion resistant particulate component is greater than about 2:1, and a binder matrix material comprising at least one member selected from the group consisting of a silicon-containing material and a phosphate-containing material.

### BRIEF DESCRIPTION OF THE DRAWINGS

The subject matter which is regarded as the invention is particularly pointed out and distinctly claimed in the concluding part of the specification. The invention, however, may be best understood by reference to the following description taken in conjunction with the accompanying drawing figures in which:

FIG. 1 is a cross-sectional view of a portion of the turbine section of a gas turbine engine.

FIG. 2 is a perspective view of a turbine disk, as viewed from the front or fan portion of the engine in the direction of gas flow, showing where an exemplary corrosion resistant coating may be desirably located.

FIG. 3 is a schematic cross-sectional view of a superalloy substrate having a surface coated with an exemplary coating as disclosed herein.

FIG. 4 is a schematic cross-sectional view of a superalloy substrate having surface coated with an exemplary coating as disclosed herein.

### DETAILED DESCRIPTION OF THE INVENTION

Exemplary embodiments are described with reference to the drawings wherein identical reference numerals denote the same elements throughout the various views.

As used herein, the term “particulate” refers to a particle, powder, flake, etc., that inherently exists in a relatively small form, or can be formed by, for example, grinding, shredding, fragmenting, pulverizing or otherwise subdividing a larger form of the material into a relatively small form.

As used herein, the term “alumina particulates” refers to particulates comprising compounds, compositions, etc., of aluminum oxide typically having the formula Al₂O₃, including hydrated and un-hydrated forms.

As used herein, the term “corrosion resistant non-alumina particulates” refers to particulates that provide corrosion resistance and comprise a metal (other than solely aluminum), a ceramic, or combination thereof that is substantially free of alumina.

As used herein, the term “substantially free” means the indicated compound, material, component, etc., is minimally present or not present at all, e.g., at a level of about 0.5% or less, unless otherwise specified.

As used herein, the term “corrosion resistant particulate component” refers to a component comprising alumina and/or non-alumina corrosion resistant particulates. The particular level and amount of corrosion resistant non-alumina particulates and alumina particulates present in the corrosion resistant particulate component can be varied depending on the coefficient of thermal expansion (CTE) properties desired for the resultant corrosion resistant coating.

As used herein, the term “metal” can refer to a single metal or a metal alloy, i.e., a blend of at least two metals.

As used herein, the term “ceramic” refers to an oxide, carbide, or nitride of a metal.

As used herein, the term “non-refractory particulates” include metal alloys having the formula: MCr, MCrX, MAl, MAIX, or MCrAlX, where M is nickel, iron, cobalt or combinations thereof, and X is any of tantalum, rhenium, yttrium, zirconium, hafnium, lanthanum, silicon, boron, carbon or combinations thereof.

As used herein, the term “aspect ratio” of a particle is a comparison of the particle length to width. As used herein, the “aspect ratio of a particulate component” is measured in the aggregate and represents an average aspect ratio of the sample.

As used herein, the term “corrosion resistant coating” refers to coatings that, after curing and firing a coating precursor composition, comprise at least one layer having an amorphous, glassy matrix or glassy-ceramic matrix and having embedded therein, encapsulated therein, enclosed thereby, or otherwise adhered thereto, particles from the corrosion resistant particulate component. Corrosion resistant coatings disclosed herein may provide resistance against corrosion caused by various corrodants, including metal (e.g., alkaline) sulfates, sulfites, chlorides, carbonates, oxides, and other corrodant salt deposits resulting from ingested dirt, volcanic ash, fly ash, concrete dust, sand, sea salt, etc., at temperatures as high as 2200° F. (1204° C.).

Exemplary embodiments disclosed herein allow for versatility in the coating. The coating precursor may be applied at various thicknesses consistent with required engineering requirements as a monolithic layer, or as a plurality of discrete layers overlying the substrate. The discrete layers may include compositional gradients of the components to provide the desired coating. Additionally, a glassy top coat may be applied over a corrosion resistant layer for cosmetic purposes, for sealing, to provide anti-stick properties, aerodynamic purposed, or for any other number of reasons. An exemplary top coat may include a commercially available metal phosphate (e.g., AlPO₄ or MgPO₄).

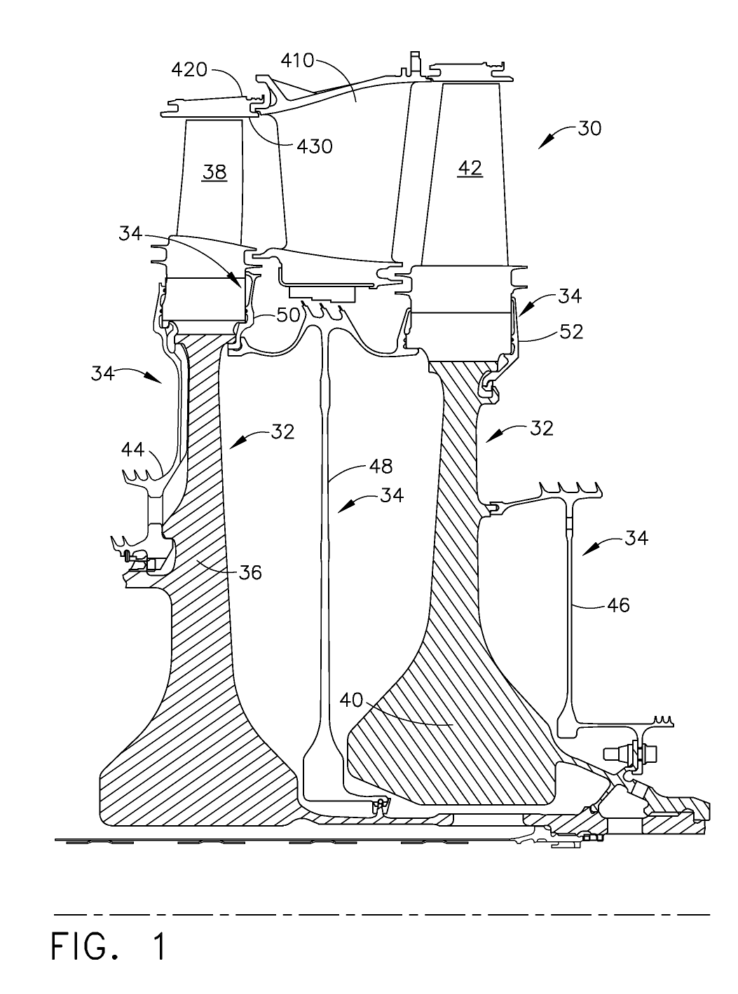

FIG. 1 illustrates a cross-sectional view depicting a portion of the turbine section of a gas turbine engine along the centerline of the engine. The turbine section 30 is a two stage turbine, although any number of stages may be employed depending on the turbine design. Turbine disks 32 are mounted on a shaft (not shown) extending through a bore in disks 32 along the centerline (CL) of the engine, as shown. A first stage blade 38 is attached to first stage disk 36, while second stage blade 42 is attached to second stage disk 40. A vane 410 extends from a casing 420. The inner surface of casing 420 forms a liner 430 for the hot gases of combustion, which flow in the gas flow path.

The first stage blade 38, the second stage blade 42 and the vane 410 extend into the hot gas flow path. The vane 410 is stationary and serves to direct the hot gas flow while blades 38 and 42, mounted on disks 36 and 40, rotate as the hot gases impinge on them, extracting energy to operate the engine. Sealing elements 34, a forward seal 44, an aft seal 46, an interstage seal 48, a stage one aft blade retainer 50 and a stage two aft blade retainer 52 serve to seal and complete the compressor air cooling circuits to the turbine blades and nozzles. These seals are attached to the disks and are rotatable therewith. Interstage seal 48 is positioned inboard of vane 410 and between the first stage disk 36 and the second stage disk 40. Also shown are optional blade retainers 50 and 52 which lock the blades to the disks. The design of such retainers will vary dependent on engine design, with some engine designs not requiring them.

These disks, seals and blade retainers are heated to the temperatures of the cooling circuit air they direct. In addition, conductive heat transfer from the combustion path parts also heats the parts closest to the combustion path. For example, the turbine blades conductively heat the rims of the turbine disks. Exemplary coatings may be used to protect any of the surfaces subject to corrosion as a result of deposition or accumulation of the cooling air contaminants.

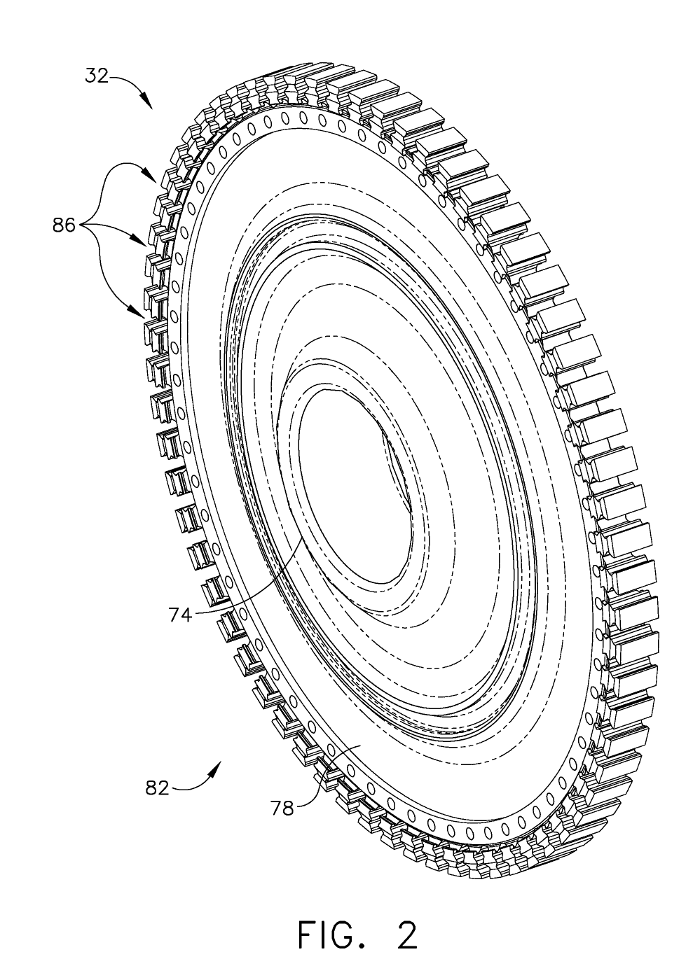

FIG. 2 is a perspective view of a typical gas turbine engine disk 82 such as disk 36 or 40 of FIG. 1, which is typically made of a superalloy material. The disk 82 includes a hub 74 along typically the engine centerline that includes a bore through which a shaft (not shown) extends. The disk 82 includes dovetail slots 86 along the disk outer periphery into which the turbine blades are inserted. A web section 78 extends between the outer periphery and the hub 74. Exemplary coatings disclosed herein may be utilized anywhere along disk 82, including the dovetail slots 86. Use of the coating along the surfaces of web section 78 and dovetail slots 86 may be particularly beneficial due to their direct exposure to cooling air. Thus, exemplary coatings disclosed herein are intended to provide corrosion protection to rotor components of gas turbine engines including disks, seals, and blade retainers, although other components or regions may benefit as well.

FIG. 3 schematically depicts an exemplary engine component 30 including a substrate 60 having an exemplary corrosion resistant coating 64. The corrosion resistant coating 64 is disposed on the surface 62 of substrate 60. The substrate 60 may be a turbine engine disk (or any portion thereof) or another engine component in need of corrosion protection. Substrate 60 may comprise a suitable superalloy based on nickel, cobalt, iron, and combinations thereof.

Prior to providing the corrosion resistant coating 64 on the surface 62 of substrate 60, the surface 62 may be pretreated mechanically, chemically, or both to prepare the surface for reception of the coating 64. Suitable pretreatment methods include grit blasting, micromachining, laser etching, treatment with chemical etchants, treatment with pressurized water, and the like, as well as combinations of one or more methods.

Exemplary coatings disclosed herein utilize a corrosion resistant particulate component 66 and a binder matrix 68 wherein at least a portion of the particulate component has an aspect ratio of greater than about 2:1. In other exemplary embodiments, the aspect ratio may be between about 2:1 and 100:1, inclusive of all sub-ranges. Other exemplary embodiments include at least a portion of the particulate component having aspect ratios of between about 10:1 to about 15:1, inclusive of all sub-ranges. It is believed that, in the coating, particulates having these high aspect ratios will generally lie parallel to the substrate surface. Therefore, a higher metal load is possible resulting in improved CTE match with the underlying substrate, and overall greater corrosion protection. The high aspect ratio particles can be formed from any semi-spherical particle via any known milling process such as traditional ball milling and attritor milling. In certain exemplary embodiments, the particulate component may include a single element (other than pure aluminum) or alloys of, for example, chromium, zirconium, nickel, cobalt, iron, titanium, yttrium, magnesium, platinum group metals (e.g., platinum, palladium, rhodium, iridium), hafnium, silicon, tantalum, etc. Exemplary embodiments may optionally include an outermost layer 70, shown in phantom, which is substantially free of corrosion resistant particulates. For example, outermost layer 70 may comprise a phosphate-containing and/or a silicon-containing glassy matrix substantially free of corrosion-resistant particulate.

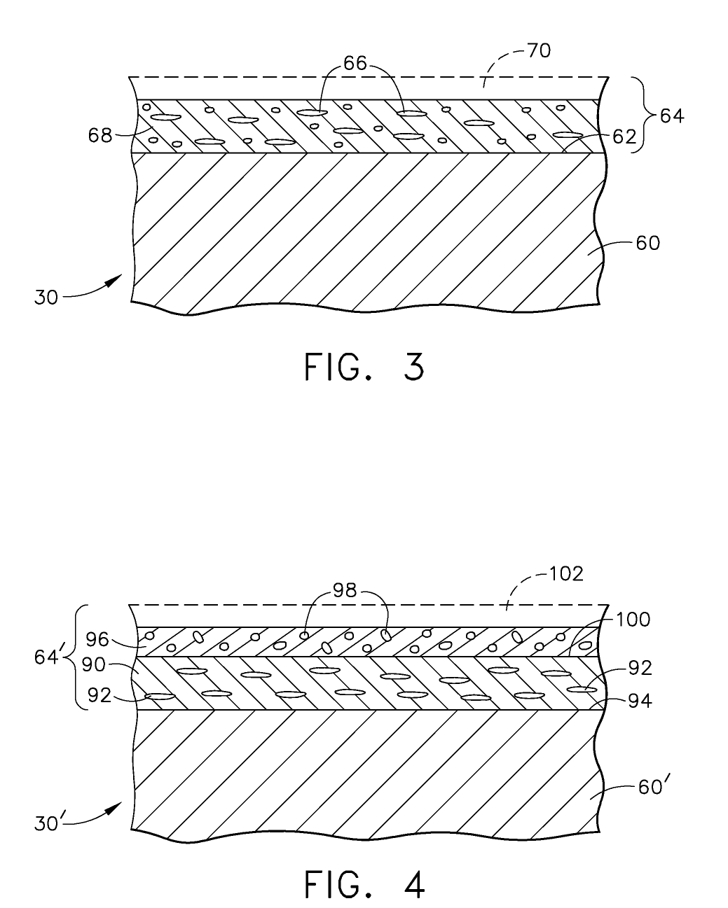

FIG. 4 schematically illustrates an exemplary coated component 30′ including a substrate 60′ having coating 64′ on a surface 62′. Coating 64′ may include at least an inner layer 90 including a higher aspect ratio corrosion resistant particulate component 92 in a binder matrix 94. In an exemplary embodiment, inner layer 90 is the innermost coating layer. Coating 64′ may also include a layer 96 comprising a corrosion resistant particulate component 98 including a bimodal particle size distribution of alumina and/or other particulate in a binder matrix 100, which may be similar or different than binder matrix 94. Layer 96 may include other corrosion resistant particulates as well. The relative thicknesses of inner layer 90 and layer 96 may be varied depending on the desired coating requirements and characteristics. As in other disclosed embodiments, coating 64′ may optionally include an outermost layer 102 (shown in phantom) comprising a phosphate-containing and/or a silicon-containing glassy matrix substantially free of corrosion resistant particulate.

Other arrangements of layers and combinations of corrosion resistant particulates are contemplated within the scope of this disclosure. For example additional layers exhibiting compositional gradients may be employed.

Certain exemplary embodiments disclosed herein include the particulates in a slurry-based coating precursor composition usable as a liquid spray. For example, the precursor composition may be formulated to provide at least one physical property (e.g., viscosity) to enable liquid spray application of the precursor composition to a metal substrate. Other exemplary embodiments disclosed herein include a slurry-based coating precursor composition that may be applied to a tape film backing, and dried to form a tape coating precursor. Exemplary embodiments disclosed herein may include the particulates in a metal phosphate matrix. The coating precursor composition may be cured to form a corrosion-resistant coating when applied over a turbine engine component or similar substrate.

In certain exemplary embodiments, the corrosion resistant particulate component generally comprises a non-refractory particulate component and/or a refractory particulate component. An exemplary corrosion resistant particulate component possesses an average coefficient of thermal expansion (CTE) greater than that of alumina (as determined at a temperature of about 1200° F., 649° C.).

An exemplary refractory particulate component may include, for example, any of zirconia, hafnia, yttria stabilized zirconia, yttria stabilized hafnia, ceria, chromia, magnesia, iron oxide, titania, yttria, yttrium aluminum garnet, singly or in combination, and optionally in combination with alumina. In other words, alumina may be present in the particulate component in combination with one or more components such that the resulting average CTE of the corrosion resistant particulate component is greater than that of alumina as defined above.

An exemplary non-refractory particulate component may include a metal material (other than solely aluminum) as a single element or alloy of, for example, chromium, zirconium, nickel, cobalt, iron, titanium, yttrium, magnesium, platinum group metals (e.g., platinum, palladium, rhodium, iridium), hafnium, silicon, and tantalum, singly or in combination. The non-refractory particulate component may include, for example, any of MCr, MCrX, MAl, MAlX, or MCrAlX, where M is nickel, iron, cobalt or combinations thereof, and X is any of tantalum, rhenium, yttrium, zirconium, hafnium, lanthanum, silicon, boron, carbon or combinations thereof.

An exemplary precursor composition may include a silicon-based binder free of hexavalent chromium, a corrosion resistant particulate component, at least a portion of which includes high aspect ratio particles, and a solvent. The silicon-based binder may be a silicone resin that produces fine porosity upon firing as well as being the silicon-containing material in the binder matrix. Other silicon-containing material including additional organics could also be used as a source of fine porosity.

Modifications are possible to improve porosity. Additionally, metal or higher CTE ceramic additions can be utilized to produce porosity and better CTE match for compliance. In exemplary embodiments, alumina material sized from 0.05 to 0.8 micrometers may be added in amounts from about 5 to about 70% by weight of the coating precursor composition. A nano alumina could also be utilized to increase final coating density. Certain exemplary embodiments include at least a bimodal particle size distribution in the corrosion resistant particulate component.

Porosity, for improved mechanical compliance, may be tailored by incorporating materials that will burn out of the precursor composition during firing, or by particle size development. Additionally, the coating may include compositionally graded layers so that there is a distinction in the associated porosity in the relevant layers. In some exemplary embodiments, the compositional make up of coating layers may differ to provide the desired porosity levels.

An exemplary tape-based coating includes a polymer-based tape system. Organic binders utilized to form the tapes are able to produce additional porosity in the coating upon firing. Exemplary binders include dibutyl pthalate (DBP) and polyvinyl butyral (available under the name B-79 from Monsanto Co.). The tapes are formed, released from the film backing, and then applied to a substrate, which may have been pre-treated for reception of the tape coating precursor. The component may be bagged and autoclaved or otherwise fired to form a ceramic coating. Exemplary corrosion resistant coating precursors may be fired at temperatures of up to about 750° F. (about 399° C.), but may be utilized at operating temperatures up to about 2200° F. (about 1204° C.). Exemplary tape systems may include multiple layers, with each layer having an associated precursor composition. Thus, a layer intended as an innermost coating layer may be formulated for optimal CTE match with a specific metal substrate while a more outer layer may be formulated for greater corrosion resistance. It is contemplated that an exemplary tape system may employ a denser top layer with a more compliant lower layer. In an exemplary embodiment, up to about 70% by weight of the tape coating precursor composition may be the high aspect ratio particulate.

Exemplary coating precursor compositions were prepared using CoNiCrAlY gas atomized powders, where at least a portion of the particles were milled to produce a high aspect ratio particulate. The precursor composition further included a silicone resin, a suitable solvent (e.g., ethyl 95%-isop 5%), and also alumina particulate. The coating precursor compositions were sprayed on suitable substrates (e.g., grit blasted Rene'88DT, a gamma prime-strengthened nickel-base superalloy disclosed in U.S. Pat. No. 4,957,567), to a target thickness of about 2.0 mils (50.8 microns). The coatings were dried, and then cured at 1000° F. (about 538° C.). The samples were compared with coatings formed from similar coating precursor compositions having a substantially spherical particulate component. Some of the samples included a spherical particulate component with an average particle size of about 6 microns. Other samples included a spherical particulate component with an average particle size of about 3 microns. The coatings with the spherical particulate component exhibited observable mud crack patterns, while those samples with the high aspect ratio particulate component did not, although the finer spherical particulate exhibited reduced frequency and severity of cracking with respect to the coarser formulation.

Optical photographs were taken of cross sections of the coated substrates. The coatings having the spherical particulate component had an exemplary thickness of about 1.8 mils (about 46 microns) and exhibited cracks extending through the coating thickness to the substrate. The coatings with the high aspect ratio particulate component had exemplary thicknesses of 2.9 mils (about 74 microns) and 1.7 mils (about 43 microns) did not show any cracking A sample with the thicker coating showed only partial penetration of the mounting epoxy. It was concluded that a particulate component having an aspect ratio of between about 10:1 and 15:1 provided beneficial outcomes by virtue of being mud crack free at thicknesses up to about 2.9 mils (74 microns), and the coatings were more densely packed as evidenced by the lack of epoxy impregnation. It is anticipated that particulate components exhibiting an aspect ratio of greater than about 2:1 would provide beneficial results.

Additional samples were prepared using a high aspect ratio particulate component at three thickness level targets (1.0 mil (25.4 micron), 2.0 mils (50.8 microns), 3.0 mils (76.2 microns)). The coating precursors were dried, and then cured as before. All samples were free of mud crack patterns. The thicker coatings exhibited surface dimples. Optical photographs were taken of cross sections of the coated substrates. No vertical cracking was observed in any of the samples. Each sample was then subjected to a thermal shock (quench) test to investigate adherence to the substrate. In the quench test, each sample was heated to 1400° F. (760° C.), held for 30 minutes, followed by quenching in room temperature water. All samples survived the water quench testing. It was concluded that a particulate component having an aspect ratio of between about 10:1 and 15:1 provided beneficial outcomes by virtue of being mud crack free at greater thicknesses, and the coatings exhibited resistance to delamination during thermal shock testing. It is anticipated that particulate components exhibiting an aspect ratio of greater than about 2:1 would provide beneficial results.

Thus, CTE matching and improved corrosion protection may be obtained by providing a coating on a metal substrate wherein the coating includes a corrosion resistant particulate component having a CTE greater than alumina at 1200° F. (649° C.), dispersed in a binder matrix, wherein an aspect ratio of at least a portion of the corrosion resistant particulate component is between about 10:1 and 15:1, and wherein the binder matrix is a silicon-containing material, a phosphate-containing material, or a combination thereof.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A coated article suitable for use at elevated temperature comprising:
a metal substrate;
a coating on the substrate, wherein the coating includes a corrosion resistant particulate component having an average coefficient of thermal expansion (CTE) greater than alumina at 1200° F. (649° C.) dispersed in a binder matrix;
wherein an aspect ratio of at least a portion of the corrosion resistant particulate component is greater than about 2:1, and
wherein the binder matrix includes at least one member of the group consisting of a silicon-containing material and a phosphate-containing material.

2. The coated article according to claim 1 wherein the aspect ratio is between about 2:1 and 100:1.

3. The coated article according to claim 1 wherein the aspect ratio is between about 10:1 and 15:1.

4. The coated article according to claim 1 wherein the substrate is a rotor component of a gas turbine engine.

5. The coated article according to claim 1 wherein the corrosion resistant particulate component comprises at least one of:
a refractory particulate component being selected from the group consisting of zirconia, hafnia, yttria stabilized zirconia, yttria stabilized hafnia, ceria, chromia, magnesia, iron oxide, titania, yttria, and yttrium aluminum garnet, and combinations thereof, and optionally in combination with alumina; and
a non-refractory particulate component being selected from the group consisting of MCr, MCrX, MAl, MAlX, MCrAlX, and combinations thereof, wherein M is an element selected from nickel, iron, cobalt, and combinations thereof, and X is an element selected from the group consisting of tantalum, rhenium, yttrium, zirconium, hafnium, lanthanum, silicon, boron, carbon, and combinations thereof.

6. The coated article according to claim 5 wherein the corrosion resistant particulate component includes, in combination, the refractory particulate component and the non-refractory particulate component.

7. The coated article according to claim 5 wherein the corrosion resistant particulate component comprises at least a bimodal distribution of particle sizes.

8. The coated article according to claim 1 wherein the corrosion resistant particulate component comprises at least a bimodal distribution of particle sizes.

9. The coated article according to claim 1 wherein the coating includes at least a first layer comprising a first amount of corrosion resistant particulate and a second layer overlying the first layer, wherein the second layer comprises a second amount of corrosion resistant particulate different from the first amount.

10. The coated article according to claim 1 wherein the coating includes at least a first layer associated with a first porosity, and a second layer overlying the first layer, wherein the second layer is associated with a second porosity different than the first porosity.

11. The coated article according to claim 1 wherein the binder matrix is the silicon-containing material being selected from the group consisting of silica (SiO₂), mullite (3Al₂O₃.2SiO₂), a silicate, and combinations thereof.

12. A coating precursor composition comprising:
a corrosion resistant particulate component having an average coefficient of thermal expansion (CTE) greater than alumina at 1200° F. (649° C.), wherein an aspect ratio of at least a portion of the corrosion resistant particulate component is greater than about 2:1; and
a binder matrix material comprising at least one member selected from the group consisting of a silicon-containing material and a phosphate-containing material.

13. The coating precursor composition according to claim 12 wherein the aspect ratio is between about 2:1 and 100:1.

14. The coating precursor composition according to claim 12 wherein the aspect ratio is between about 10:1 and 15:1.

15. The coating precursor composition according to claim 12 wherein the corrosion resistant particulate component includes at least one of:
a refractory particulate component being selected from the group consisting of zirconia, hafnia, yttria stabilized zirconia, yttria stabilized hafnia, ceria, chromia, magnesia, iron oxide, titania, yttria, and yttrium aluminum garnet, and combinations thereof, and optionally in combination with alumina; and
a non-refractory particulate component being selected from the group consisting of MCr, MCrX, MAl, MAlX, MCrAlX, and combinations thereof, wherein M is an element selected from nickel, iron, cobalt, and combinations thereof, and X is an element selected from the group consisting of tantalum, rhenium, yttrium, zirconium, hafnium, lanthanum, silicon, boron, carbon, and combinations thereof.

16. The coating precursor composition according to claim 12 wherein the corrosion resistant particulate component includes, in combination, the refractory particulate component and the non-refractory particulate component.

17. The coating precursor composition according to claim 16 wherein the corrosion resistant component comprises at least a bimodal distribution of particle sizes.

18. The coating precursor composition according to claim 12 wherein the corrosion resistant particulate component comprises at least a bimodal distribution of particle sizes.

19. The coating precursor composition according to claim 12 having at least one physical property enabling application of the precursor composition to a metal substrate using a liquid spray application technique.

20. The coating precursor composition according to claim 12 being carried on a tape film backing.
